(19) United States
(12) Patent Application Publication
(10) Pub. No.: US 2020/0086732 A1
(43) Pub. Date: Mar. 19, 2020

(54) COLD 48-VOLT ENGINE START USING 12-VOLT BATTERY

(71) Applicant: Continental Powertrain USA, LLC, Auburn Hills, MI (US)

(72) Inventors: Benjamin Bargman, Beverly Hills, MI (US); Brian J. McKay, West Bloomfield, MI (US)

(21) Appl. No.: 16/532,644

(22) Filed: Aug. 6, 2019

Related U.S. Application Data
(60) Provisional application No. 62/732,315, filed on Sep. 17, 2018.

(51) Int. Cl. B60K 6/24; H02M 3/158

(52) U.S. Cl. CPC B60K 6/24; H02M 3/1582

(57) ABSTRACT

A system for starting an internal combustion engine of a hybrid vehicle includes a 12-volt battery; a 48-volt battery; a DC-DC converter in electrical communication with the 12-volt battery and with the 48-volt battery; and an electric machine in electrical communication with the 48-volt battery. The electric machine is mechanically connected to an engine. In a first initial or cold start mode of operation, the DC-DC converter receives voltage from the 12-volt battery, boosts the voltage to a voltage of about 48 volts, with 48-volt power being applied to the electric machine for activating the electric machine, causing the electric machine to start the engine. In a second mode of operation, the electric machine receives 48 volt power, from the 48-volt battery alone, for activating the electric machine, causing the electric machine to start the engine.

### CROSS-REFERENCE TO RELATED APPLICATIONS

This application claims the benefit of the earlier filing date of U.S. Provisional Application No. 62/732,315, filed on Sep. 17, 2018, which is incorporated by reference herein in its entirety.

### FIELD OF THE INVENTION

The invention relates generally to a hybrid electric vehicle (HEV) and, more particularly, to a system and method for starting an internal combusting engine of the HEV at initial or cold start using a 12 volt battery.

### BACKGROUND OF THE INVENTION

Hybrid electric vehicles are becoming increasingly common, and use a combination of an internal combustion engine and various electric motors to provide propulsion of the vehicle. It is generally considered desirable that a hybrid electric vehicle have the ability to function under various operating conditions. Lithium ion batteries are commonly used in hybrid electric vehicles because lithium ion batteries have the ability to be discharged and recharged many times and still maintain a desired performance level.

With reference to FIGS. 1A and 1B, a typical hybrid electric vehicle incorporates a system, generally indicated at 10, for starting an internal combustion engine 12. The system 10 includes a combination of a common 12-Volt lead acid or absorbent glass mat (AGM) battery 14 and a lithium ion battery 16. In FIGS. 1A and 1B, dashed lines between components indicate an electrical connection and solid lines between components indicate electricity transfer. The 12-Volt battery is typically used in combination with a pinion starter 18 to start the internal combustion engine 12 in cold ambient temperatures (i.e., such as −15° C. or less), or for initial activation of the engine after the engine has been inactive for an extended period of time, since the lithium ion battery 16 is unable to supply high power at low ambient temperatures. If the vehicle has been shut down (e.g., with the start button or by removal of the key) the system will default to the use of 12V pinion starter the next time the engine starts.

The lithium ion battery 16 is typically used to power the electric motors when needed, and is used to provide power to a 48-Volt or high voltage (HV) belt-starter-generator (BSG) 20 to restart the engine 12, via a belt-pulley system 13, after the engine has been inactive for limited, or short periods of time as shown in FIG. 1B. The vehicle transmission is shown at 22 and a conventional DC-DC converter, for keeping batteries 14 and 16 charged, is shown at 24 in FIGS. 1A and 1B. As noted above, lithium ion batteries used in hybrid electric vehicles typically operate at higher voltage levels compared to lead acid batteries, such 48-Volts or higher, but have poor performance in cold temperatures, such as −15° C. or less.

Accordingly, there exists a need for a system used for starting an internal combustion engine, which is able to use either of the 12-Volt battery or the 48-Volt/HV battery to provide power to a belt-starter-generator to start an engine, based on ambient temperature, or how long the engine has been inactive, without the need for a pinion starter.

### SUMMARY OF THE INVENTION

An objective of the invention is to fulfill the need referred to above. In accordance with the principles of and embodiment, this objective is achieved by providing a system for starting an internal combustion engine of a hybrid vehicle. The system includes a 12-volt battery; a 48-volt battery; a DC-DC converter in electrical communication with the 12-volt battery and with the 48-volt battery, with the DC-DC converter being constructed and arranged to boost voltage from the 12-volt battery to voltage of about 48-volts; and an electric machine in electrical communication with the 48-volt battery and with the DC-DC converter. The electric machine is mechanically connected to an engine. In a first mode of operation, the DC-DC converter is constructed and arranged to receive voltage from the 12-volt battery, to boost the voltage to a voltage of about 48 volts, with 48-volt power being applied to the electric machine for activating the electric machine, causing the electric machine to start the engine. In a second mode of operation, the electric machine is constructed and arranged to receive 48 volt power, from the 48-volt battery alone, for activating the electric machine, causing the electric machine to start the engine.

In accordance with another aspect of an embodiment, a method for starting an internal combustion engine of a hybrid vehicle provides a 12-volt battery and a 48-volt battery. A DC-DC converter is electrically connected with the 12-volt battery and with the 48-volt battery, with the DC-DC converter being constructed and arranged to boost voltage from the 12-volt battery to voltage of about 48-volts. An electric machine is mechanically connected to the engine, and the electric machine is electrically connected with the 48-volt battery and with the DC-DC converter. Under conditions wherein the 48-volt battery is unable to deliver 48 volt power to the electric machine, the method provides voltage from the 12-volt battery to the DC-DC converter, with the DC-DC converter boosting the voltage to a voltage of about 48 volts, and applying 48-volt power to the electric machine to activate the electric machine, causing the electric machine to start the engine. Under conditions wherein the 48-volt battery is able to deliver 48 volt power to the electric machine, the method provides 48 volt power, from the 48-volt battery alone, to the electric machine to activate the electric machine, causing the electric machine to start the engine.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1A is diagram of a conventional system for starting an internal combustion engine of an HEV shown operating in a first mode, providing 12V power to a pinion starter.

FIG. 1B is diagram of the conventional system of FIG. 1A, shown operating in a second mode, with the 48V battery providing power directly to an electric machine.

FIG. 2A is diagram of a system for starting an internal combustion engine in an HEV in accordance with an embodiment, shown operating in a first mode, with power from the 12V battery being boosted by a DC-DC converter and then delivered to the electric machine to start an engine.

FIG. 2B is diagram of the system of FIG. 2A, shown operating in a second mode, with the 48V battery alone providing power to the electric machine to start the engine.

### DETAILED DESCRIPTION OF THE PREFERRED EMBODIMENTS

The following description of the preferred embodiment(s) is merely exemplary in nature and is in no way intended to limit the invention, its application, or uses.

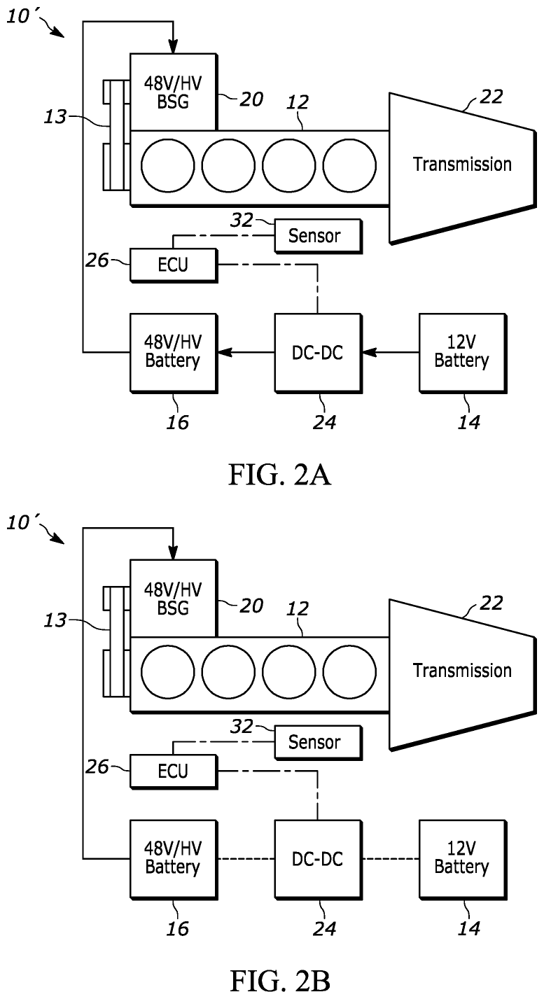

With reference to FIGS. 2A and 2B, a system for starting an internal combustion engine 12 of a hybrid electric vehicle (HEV) is shown, generally indicated at 10′, in accordance with an embodiment. In FIGS. 2A and 2B, dashed lines between components indicate an electrical connection and solid lines between components indicate electricity transfer. The hybrid electric vehicle includes the internal combustion engine 12 connected to the transmission 22, and an electric machine 20. In the embodiment, the electric machine 20 is preferably in the form of a belt-driven starter-generator (BSG) that operates at 48 Volts and is directly coupled to the engine 12 by a belt and pulley system 13 to start the engine 12. The system 10′ includes a 12-Volt battery 14, which is preferably a lead-acid battery. The 12-Volt battery 14 is in electrical communication with a DC-DC converter 24, and the converter 24 is in electrical communication with a 48-Volt battery 16. The 48-Volt battery 16 is in electrical communication with the electric machine or BSG 20. The DC-DC converter 20 controls the flow of electricity and can operate in three modes. A buck mode steps down 48V power to 12V power. This mode is used to charge the 12V battery 14 with the energy created by the BSG 20. A boost mode steps up 12V power to 48V power. This boost mode is used to provide extra power to the BSG 20 when the 48V battery has limited power. An idle mode is when no power transfer occurs.

An electronic control unit (ECU) 26 is electrically connected with the DC-DC converter 24 and the ECU 26 is also electrically connected with a sensor 32. The sensor 32 can be a temperature sensor and/or a timer that determines an amount of time the engine 12 has been in a deactivated condition, the function of which will be explained below.

FIG. 2A shows a first example of the operation of the system 10′, according to the embodiment. The 12-Volt battery 14 provides a source of DC current to the DC-DC converter 24. The voltage generated from the 12V battery 14 is boosted by the DC-DC converter 20 (in the boost mode) from about 12 Volts to about 48 Volts, and the 48-Volt power directed through the 48V battery 16 activates the BSG 20, which in turn starts the engine 12. Preferably, if the vehicle had been shut down with the start button or by removal of the key, for the next engine 12 start, the 12V battery 14 is used as the boosting power source for the BSG 20 to start the engine 12. However, instead of automatically employing the 12V battery for initial engine start, based on a signal from the temperature sensor 32 or based on a current capability/status message from the battery management system (not shown), the ECU 26 can determine if the 48V battery alone is capable powering an initial engine start.

As noted above, the 48-Volt lithium ion battery 16 is unable to supply high power to the BSG 20 at low ambient temperatures. Thus, the engine initial or cold start mode of operation shown in FIG. 2A is initiated by the ECU 26 controlling the DC-DC converter 20 to operate in the boost mode using the 12V battery power to boost the 48V battery power that is directed to the BSG 20. In additional to initial engine start, the boost mode of the DC-DC converter 20 can be used upon cold start, when ambient temperatures are less than −15° C., or when the engine 12 has been deactivated for an extended period of time, such as eight hours or longer, as determined by sensor 32.

Another example of the operation of the system 10′ according to the embodiment is shown in FIG. 2B. In FIG. 2B, the lithium ion 48-Volt battery 16 alone is used to directly activate the BSG 20, which in turn starts the engine 12. This restart mode of operation shown in FIG. 2B is initiated by the ECU 26 deactivating the boost mode of the DC-DC converter 20 when ambient temperatures are warm, such as greater than −15° C., or when the engine 12 has been deactivated for a limited or short period of time, such as less than eight hours as determined by sensor 32.

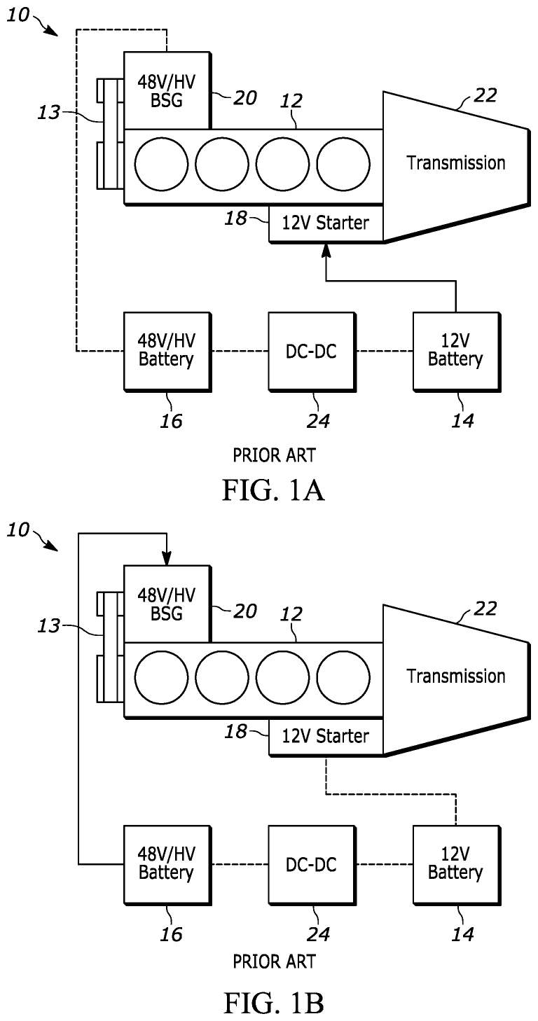

In either of the modes of operation described above, the need for the 12-Volt battery 14 to supply power to a pinion starter is eliminated, and therefore the pinion starter 18 of FIGS. 1A and 1B is eliminated, since the embodiment shown in FIGS. 2A and 2B permits starting of the engine 12 under various temperatures and conditions. Eliminating the starter 18 reduces costs, complexity, and weight.

While the present invention has been shown for use in a hybrid vehicle having a P0 (belt-drive connection of electric machine to front of engine) architecture as shown in FIGS. 2A and 2B, it is within the scope of the invention that the system of the present embodiment may be used in any type of mild hybrid electric vehicle architecture, such as P1, P2, P3 . . . Pₓ, where the 48V electric machine 20 is placed behind the engine 12 and connected to the engine by a belt, gear mesh, or other connection.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for starting an internal combustion engine of a hybrid vehicle, the system comprising:
a 12-volt battery;
a 48-volt battery;
a DC-DC converter in electrical communication with the 12-volt battery and with the 48-volt battery, the DC-DC converter being constructed and arranged to operate in a boost mode to boost voltage from the 12-volt battery to voltage of about 48-volts; and
an electric machine in electrical communication with the 48-volt battery and with the DC-DC converter, the electric machine being mechanically connected to an engine,
wherein, in a first mode of operation, the DC-DC converter is constructed and arranged to receive voltage from the 12-volt battery, to boost the voltage to a voltage of about 48 volts, with 48-volt power being applied to the electric machine for activating the electric machine, causing the electric machine to start the engine, and
wherein, in a second mode of operation, the electric machine is constructed and arranged to receive 48 volt power from the 48-volt battery alone for activating the electric machine, causing the electric machine to start the engine.

2. The system of claim 1, wherein the electric machine is a belt-starter-generator.

3. The system of claim 1, wherein the 12-volt battery is a lead-acid battery.

4. The system of claim 1, wherein the 48-volt battery is a lithium ion battery.

5. The system of claim 1, further comprising an electronic control unit (ECU) electrically connected with the DC-DC converter, wherein in the first mode operation, the ECU is constructed and arranged to control the DC-DC converter to operate in the boost mode upon initial start of the vehicle.

6. The system of claim 1, further comprising:
an electronic control unit (ECU) electrically connected with the DC-DC converter, and
a sensor electrically connected with the ECU,
wherein, in the first mode of operation, the ECU is constructed and arranged to control the DC-DC converter to operate in the boost mode to boost the voltage received from the 12-volt battery when an ambient temperature is less than −15° C., or when the engine has been deactivated for an extended period of time as determined by the sensor, and
wherein, in the second mode of operation, the ECU is constructed and arranged to deactivate the boost mode of the DC-DC convertor when an ambient temperature is greater than −15° C., or when the engine has been deactivated for a limited time as determined by the sensor.

7. The system of claim 6, wherein the sensor is a temperature sensor constructed and arranged to measure the ambient temperature.

8. The system of claim 6, wherein the sensor is a timer constructed and arranged to determine an amount of time that the engine has been deactivated.

9. A method for starting an internal combustion engine of a hybrid vehicle, the method comprising the steps of:
providing a 12-volt battery;
providing a 48-volt battery;
electrically connecting a DC-DC converter with the 12-volt battery and with the 48-volt battery, the DC-DC converter being constructed and arranged to operate in a boost mode to boost voltage from the 12-volt battery to voltage of about 48-volts; and
mechanically connecting an electric machine to the engine, and electrically connecting the electric machine with the 48-volt battery and thus with the DC-DC converter,
under conditions wherein the 48-volt battery is unable to deliver 48 volt power to the electric machine, providing voltage from the 12-volt battery to the DC-DC converter, with the DC-DC converter, in the boost mode, boosting the voltage to a voltage of about 48 volts to provide 48-volt power,
applying the 48-volt power to the electric machine to activate the electric machine, causing the electric machine to start the engine, and
under conditions wherein the 48-volt battery is able to deliver 48 volt power to the electric machine, providing 48 volt power, from the 48-volt battery alone, to the electric machine to activate the electric machine, causing the electric machine to start the engine.

10. The method of claim 9, wherein the step of mechanically connecting the electric machine to the engine includes using a belt and pulley system.

11. The method of claim 10, wherein the electric machine is a belt-starter-generator.

12. The method of claim 9, wherein the 12-volt battery is provided as a lead-acid battery.

13. The method of claim 9, wherein the 48-volt battery is provides as a lithium ion battery.

14. The method of claim 9, wherein the step of providing voltage from the 12-volt battery to the DC-DC converter to boost the voltage from the 12-volt battery occurs under conditions where an ambient temperature is less than −15° C., or when the engine has been deactivated for an extended period of time.

15. The method of claim 13, wherein the extended period of time is at least 8 hours.

16. The method of claim 9, wherein the step of providing voltage from the 12-volt battery to the DC-DC converter to boost the voltage from the 12-volt battery occurs upon initial start of the engine.

17. The method of claim 9, wherein the step of providing 48 volt power, from the 48-volt battery alone, to the electric machine occurs under conditions where an ambient temperature is greater than −15° C., or when the engine has been deactivated for a limited period of time.

18. The method of claim 17, wherein the limited period of time less than 8 hours.

19. The method of claim 9, further comprising the steps of:
electrically connecting the DC-DC converter and a sensor to an electronic control unit (ECU),
wherein, the ECU controls the DC-DC converter to operate in the boost mode when an ambient temperature is less than −15° C., or when the engine has been deactivated for an extended period of time as determined by the sensor, and
wherein, the ECU controls the DC-DC converter to deactivate from the boost mode so that the 48 volt power is applied, from the 48-volt battery alone, to the electric machine when an ambient temperature is greater than −15° C., or when the engine has been deactivated for a limited time as determined by the sensor.

20. The method of claim 19, wherein the sensor is provided as a temperature sensor to measure the ambient temperature or as a timer to determine an amount of time that the engine has been deactivated.
